(19) United States
(12) Patent Application Publication
(10) Pub. No.: US 2014/0282038 A1
(43) Pub. Date: Sep. 18, 2014

(54) FLIGHT DETAIL APPLICATION AND INTERACTIVE MAP SYSTEM AND METHOD

(71) Applicant: InTheAirNet, LLC., Irvine, CA (US)

(72) Inventors: Howard Isham ROYSTER, Lafayette, CA (US); Michael J. ROGERSON, Irvine, CA (US); Benjamin Alexander MEDVITZ, Irvine, CA (US)

(73) Assignee: InTheAirNet, LLC., Irvine, CA (US)

(21) Appl. No.: 14/204,950

(22) Filed: Mar. 11, 2014

Related U.S. Application Data
(60) Provisional application No. 61/793,770, filed on Mar. 15, 2013.

(51) Int. Cl. G06F 3/0484; B64D 11/00

(52) U.S. Cl. CPC G06F 3/0484; B64D 11/0015
USPC 715/738

(57) ABSTRACT

Methods and systems for providing a passenger with a comprehensive software application that is associated with the passenger's flight plan and is spatially aware of the passenger's location and/or feedback with the application in order to assist the passenger with flight related tasks is disclosed. The method includes providing a different interactive map to each of a plurality of passengers on an aircraft can include packaging and transmitting flight specific data, graphical representation of the retrieved map imagery data, and the text layer with a server based application for receipt by a client based application for display and interaction, requiring additional packaging and transmitting. Alternative methods include providing an interactive map by requesting and receiving flight specific data and map imagery using a client based application running on a personal electronic device (PED) and then rendering and displaying the map imagery data per instructions of the client based application.

This application claims the benefit of U.S. Provisional Patent Application No. 61/793,770, filed on Mar. 15, 2013, which is hereby incorporated by reference as if fully set forth herein.

### FIELD OF THE DISCLOSURE

This application relates generally to a flight detail assistance application and interactive map systems on or associated with aircraft in-flight systems and/or dedicated terrestrial systems, and more particularly to allowing a user/passenger to access and/or control information related to or concerning the passenger's flight on their personal electronic devices (PEDs) and to allow the passengers interactive control over a map display on their PEDs.

### BACKGROUND OF THE DISCLOSURE

Most, if not all, aircraft that provide in-flight entertainment displays offer some sort of map illustrative of the vessels' current position, along with other useful information such as time, altitude, temperature, expected local arrival time, and remaining flight time to name a few. The maps may be highly detailed or simple displays. The provided maps become increasing important during longer flights where passengers need supplemental sensory input (particularly when crossing multiple time zones) to assist in regulating things like sleeping, eating, limited physical movement, and entertainment (i.e., passing the time). Simply put, it appears to help to know things like how much longer the flight is and what time it will be when you arrive at your destination.

Although there have been recent improvements in in-flight map services, most improvements can be generically described as simply providing more data to the user/passenger. For example, providing factoids or pictures of the origination city, destination city, or locals along the flight path. While such features are an improvement, what is needed is a system that, while conveying the same useful data, provides a simulator or game like environment to the map display. Another feature that has been lacking in prior systems is to allow a user/passenger to enjoy the benefits of an in-flight map service utilizing their personal electronic device (PED). If the flight data is coupled with a specialized application, the full advantages of the enhanced map system can be enjoyed. Likewise, the enhanced map system is still capable of interfacing with and providing useful data to third party map displays.

There is likewise a myriad of information available to a passenger related to their airline travel, such as information about the departure airport, connecting flights, the destination airport, the destination city, transit options, hotels, restaurants, etc. Known systems and methods for obtaining the information on these many items is to individually access mostly disparate systems and obtain the information piecemeal. This type of information is rarely, if ever, based on real-time feedback from the passenger. That is, none of the known systems functions with spatial awareness of the passenger's location and/or interaction with the individual systems.

Therefore, what is needed is a system/method that is spatially aware of the passenger's location and/or feedback with the system in order to provide appropriate information to the passenger automatically or through interaction with the passenger. Also what is needed is an interactive map display system/method that provides the passenger with significant ability to interact with the map.

### SUMMARY

A method and system for providing a different interactive map to a plurality of passengers on an aircraft is disclosed. The method comprises receiving and converting flight specific data from an aircraft interface module; retrieving map imagery data stored on a media server located on the aircraft; first rendering a graphical representation of the retrieved map imagery data; second rendering a text layer to be overlaid on the graphical representation of the retrieved map imagery data from the media server; packaging the flight specific data, the graphical representation of the retrieved map imagery data, and the text layer with a server based application; transmitting the package data to a client based application for display; receiving request from the client based application for different imagery and text data; and repeating the retrieving, first and second rendering, packing, and transmitting steps based on received request from the client based application.

The method may allow the client application to have no map imagery data. The package data may be configured to permit no rendering to be done by the client application during display. The method may further include sending a map of a destination airport to the client based application on a passenger PED, the map including a terminal map and restaurants. The method may also include sending an assigned baggage claim number at the destination airport for the aircraft and associated flight to the client based application and/or sending government customs procedures at the destination airport to the client based application.

A method and system for providing a different interactive map to a plurality of passengers on an aircraft is also disclosed. The method comprises requesting flight specific data and map imagery using a client based application running on a personal electronic device (PED); receiving a raw data stream from a server application comprising converted flight specific data, and stored map imagery data; rendering the map imagery data per instructions of the client based application; displaying the rendered map imagery data and a text layer; requesting from the server based application different imagery and text data; and repeating the receiving, rendering, and displaying steps based on subsequent request from the client based application.

The method may include receiving at least one polling request on the PED as to whether the passenger has boarded an aircraft, connecting to an in-flight server of the aircraft upon receipt of the polling request via the PED, and downloading data for generating a visual map associated with the aircraft on the PED. The method can further include continuously receiving flight specific data on the PED while on board the aircraft, the flight specific data including aircraft position and expected landing time.

In an embodiment, a disclosed method includes detecting a position of an aircraft based on data from a aircraft interface module, calculating an expected arrival time of the aircraft at a destination airport based on the aircraft position, determining whether the aircraft is ahead or behind schedule based on the expected arrival time, retrieving a flight itinerary for a passenger personal electronic device (“PED”) including a scheduled connecting flight at the destination airport, providing an earlier connecting flight to the passenger PED for booking if the aircraft is ahead of schedule, and providing a later connecting flight to the passenger PED for booking if the aircraft is behind schedule. The method can also include automatically re-booking the later connecting flight when the scheduled connecting flight has already departed the destination airport. The method may include checking a set of permissions and preferences on the passenger PED prior to re-booking to determine whether automatic re-booking is enabled.

The preferences may specify a minimum layover time between the expected arrival time and departure time of an alternative connecting flight. The preferences may also specify alternative airports to reach as a final destination. The detected position may be based on aircraft position information from an in-flight server, global positioning system (“GPS”), and/or wifi location data.

### BRIEF DESCRIPTION OF THE DRAWINGS

FIG. 1 illustrates an exemplary in-flight system according to one embodiment of the disclosure.

FIG. 2 illustrates a generic component architecture for a personal electronic device (PED) that may be used in association with the in-flight system according to one embodiment of the disclosure.

FIG. 3a illustrates a method for providing a in-flight map display with a majority of processing and image rendering performed on the server.

FIG. 3b illustrates a method for providing a in-flight map display with a majority of processing and image rendering performed on the client (i.e. PED).

FIG. 4 illustrates a method for providing flight plan and associated details (including a map) to a user/passenger on board a flight or associated with a flight, including the ability to interact with the map according to one embodiment of the disclosure.

FIG. 5 illustrates a method of automatic PED prompt including requesting permission for spoofed GPS data according to one embodiment of the disclosure.

FIGS. 6A-6C illustrate three spatial environments related to customized software application loaded onto a passenger's PED. FIG. 6A shows the PED located at the departure airport and connected wireless to the departure airport's wifi. FIG. 6B shows the PED located onboard an aircraft and connected either via a wired connection or wireless to the aircraft's onboard servers.

FIG. 6C shows the PED located at the destination airport and connected wireless to the destination airport's wifi.

### DETAILED DESCRIPTION

FIG. 1 illustrates an exemplary in-flight system according to one embodiment of the disclosure. The in-flight system may include one or more servers 120 serving a plurality of seats 130 or alternatively serving a set of wired (e.g., cables) or wirelessly connected devices, for example, user provided PEDs. Other digital or analog techniques and devices to perform communication over a local area network (LAN), wide area network (WAN), or the internet, for example, may be used. Communication within the system may take place using sockets, ports, and other mechanisms known in the art.

In the embodiment of FIG. 1, a plurality of servers 120 are installed throughout an aircraft or other type of passenger vessel, such as a bus or ship. Each server 120 serves a plurality of devices, for example seats 130 or within range PEDs, in its vicinity, in one embodiment, up to ten devices. However, generally, the number of seats that the server 120 may serve depends on the processing power of the server 120. If the vessel chooses to provide fixed viewing displays for each passenger, a seat display unit (SDU) may be connected to one associated server 120 via an electrical connection such as, for example, Ethernet, Universal Serial Bus (USB), and the like.

In an alternative embodiment, a PED may be hardwire connected or wirelessly connected to the server 120, for example, using either Ethernet, Universal Serial Bus (USB), or a similar communication protocol, or a wireless communication device compatible with the wireless communication component of the PED. In at least one embodiment, the PEDs are connected via a wired connection, e.g. USB, as further detailed in U.S. application Ser. No. 13/230,675 filed Sep. 12, 2011, entitled “In-Flight System” which is incorporated herein by reference in its entirety for all purposes. In one embodiment, the in-flight system is configured to connect wirelessly to a user PED when they enter the aircraft and if the necessary application software is not available on the PED, the in-flight system may offer to push the application software, so that when the user reaches their seat, their PED comprises the necessary software (e.g., smart phone application) to access the in-flight system, access or control related flight information, and access to an interactive map environment. For example, a HTTP server push may be used. In one embodiment, when the user connects their PED to the in-flight system, only the specific application software may be used on the PED, and all other functions/applications are disabled. The application software may be referred to as a flight details application.

In general, the word application, as used herein, refers to logic embodied in hardware or software instructions, which can be written in a programming language, such as Java™, PHP, Perl, PHP, HTML, CSS, and/or JavaScript, for example. A software application can be compiled into executable programs or written in interpreted programming languages. Software applications may be callable from other applications, engines, or themselves. Generally, the applications described herein refer to logical modules that may be merged with other engines or applications or divided into sub-engines despite their physical organization. The applications can be stored in any type of computer readable medium or computer storage device and be executed by one or more general purpose computers. In addition, the methods and processes disclosed herein can alternatively be embodied in one or more applications, or specialized computer hardware.

An aircraft interface module 110 may be connected to the server 120 to provide, among other things, flight data such as GPS coordinates, speed, altitude, time, temperature, yaw, pitch, and roll values. This data may be used by the server 120, for example, in conjunction with a map application either at the server 120 or on a user's PED, to provide the user with information regarding the status of the flight. Usually, the communication between aircraft interface module 110 and server 120 is a one-way communication, that is, aircraft interface module 110 sends flight data and server 120 receives and then utilizes or distributes the flight data. Of note, Aircraft interface module 110 and server 120 may reside on physically separate machines, such as computers, or be on the same machine. In addition, the illustrated system and devices may be configured to operate in local, remote, or cloud computing environments.

In one embodiment, a media loader module 150 may be connected to the server 120. The media loader module 150 may be used to upload and/or download media contents and information to/from the aircraft from/to an external entity 140. External entity 140 may be third party media content providers, the airline, or another aircraft. Alternatively, external entity 140 may be a terrestrial media storage facility for the in-flight system. Media loader module 150 may communicate with the external entity 140 through a wired or wireless communication medium while the aircraft is on the ground, or solely through a wireless communication medium while the aircraft is taxing or flying at an altitude while wireless communication is possible, or through a satellite at high altitudes. In one embodiment, media loader module 150 is used to load specialized materials (e.g., GUIs, fonts, graphics, etc.) and/or mass media updates from local removable storage that would be more efficiently updated locally than via an external entity 140. Additional description regarding the above described hardware architecture, as illustrated in FIG. 1, and its function can be found in U.S. application Ser. No. 13/230,675 filed Sep. 12, 2011, entitled “In-Flight System” which is incorporated herein by reference in its entirety for all purposes.

Server 120, and other devices shown, can include one or more central processing units (CPUs), a memory, such as random access memory (RAM), to store information temporarily or permanently, one or more input/output (I/O) devices and interfaces, such as a network interface or card, keyboard, and the like to receive or transmit data. Sever 120 may further comprise a storage device, such as one or more hard drives. The storage device includes one or more data repositories having a variety of structured or unstructured content, such as file systems or databases. Components of server can be interconnected using a standards based bus system, such as Peripheral Component Interconnect (PCI), for example. Server 100 may include various operating systems, web servers, hardware resources. The operating systems and other software may manage the various hardware resources, and provide a graphical user interface (GUI) through a web server, for example.

FIG. 2 illustrates a generic component architecture for a personal electronic device (PED) that may be used in association with the in-flight system according to one embodiment of the disclosure. The PED 200 comprises an applications processor 210 and a communications processor 220. The function of these two illustrated separate processors may be performed on a single processor. Data can be inputted to the processor(s) via user input 230, audio 250, data interface 260, and camera 270. Information is communicated to the user via a display 240, audio 250 and the data interface 260. The processor transmits and receives data wirelessly through at least two paths as illustrated in FIG. 2. The wireless communications paths are telephony 280 or broadband 290. PED 200 can also communicate in a wired fashion through data interface 260.

In one embodiment, the applications and communications processor 210/220 may operate under one or more platforms. In an embodiment, the PED 200 at least supports the Google Android™ application programming interface (API) provided by the Android™ platform. The PED 200 may run one or more Android™ applications in order to communicate with the server 120 that also runs on a platform, for example the Android™ platform. The PED 200 preferably communicates with the server 120 through wireless and the like, but is also configured to communicate with server 120 via a wired connection. When the PED 200 is accessing server 120 via a wireless network using, for example, wireless fidelity (“wifi”) protocol, the PED 200 may be implemented using Android™ android.net.wifi package to access the server. Further information on the Android™ application programming interface (API) and software development kit (SDK) may be found at http://developer.android.com/sdk/index.html.

Data regarding the aircraft's position, including but not limited to longitude, latitude, altitude speed, and heading are communicated via the server 120 to PED 200 (illustrated by two different embodiments in FIGS. 3a and 3b). Upon receipt of the data by PED 200, the PED 200 utilizes the data to communicate the aircraft's position visually. This could be as simple as providing a plurality of variables and their value in plain text, but is most useful and best understood when presented in the form of a visual map display. Individual map implementations will be discussed in more detail below.

Although it is possible to use a third party map application and “spoof” the GPS information, a process that will be detailed further below, an interactive map system as disclosed herein realizes its full potential with a customized (i.e. proprietary) map application that is written for the exact data provided by the Aircraft Interface Module 110 and the stored map graphics delivered by the server 120. Such an application utilizes the broadband 290 connection controlled by the communications processor 220 to most efficiently communicate the data to the applications processor 210 running the specifically designed application. The interactive map application drives the PED 200 to produce an output on the display 240 which can be interacted with via the user input 230 which may consist of numerous keys/buttons or may be a touchscreen interface coupled to the display 240. Specific operational strategies will be discussed further below with reference to FIGS. 3-5.

The present disclosure contemplates, in one embodiment, a custom designed flight details application, a major component of which is the map display function, running on either a passenger's PED or on in-seat hardware, which may represent the same or similar hardware as a passenger's PED, but be located in a fixed position (e.g., headrest or seat arm). The flight details application receives data from the server 120 via either a wired or wireless connection. The map application utilizes the data from the server 120 to render a visual map environment on the passenger's PED. The data may be utilized to render a plurality of different map views, for example, a globe view, a day/night boundary view, a satellite view, a night view, an information view, a time zone view, a plurality of 3-D views, a direction view, and a information view, to name a few. Several of these views allow the user to “interact” with the map. In the present disclosure, interaction means moving through the map in a game-like manner. This means that a user/passenger can fly through the map to experience different sights without being limited to the flight plan.

Such an experience requires an increase in processor power and bandwidth. As each passenger can now experience the map in a unique manner (i.e., that no two passenger will interact with the map identically), the data stream to each device will also be unique. The only constant data amongst the plurality of users will be the actual flight data. Each user that chooses to interact with the map will require a unique set of map imagery data. In one embodiment, all imagery data is saved on board the vessel and queued to the user as requested. In another embodiment, the server 120 initially only queues up the map imagery along the anticipated flight path. In one embodiment, as a user interacts with a map view, the most recent map imagery data received from server 120 is queued locally by PED 200. The server 120 may also comprise a repository of non-real time information (e.g., locale factoids, trivia, names of geographical features, etc. . . . ) that are transmitted to PED 200 for presentation with other map views, whether an interactive view or a static view. In one embodiment, the flight details application in conjunction with the flight management system (e.g., aircraft interface module, flight computer, server 120, etc. . . . ) is spatially aware of the vessel's present location in relation to the saved imagery and information database on server 120 and automatically triggers a communication to users that authorize such communication (e.g., e-mails, texts, advertisement banners within the map application, etc. . . . ). In at least one embodiment, all or the majority of imagery and information data rendering is performed by the PED 200 and the server 120 is merely transmitting data. This reduces the processor load at server 120 and more efficiently utilizes the collective processing power of devices (i.e., PED) brought on board the vessel. Specific implementations will now be discussed, but should not be considered limiting in practicing the present disclosure. A person of ordinary skill in the art would recognize that there are a plurality of ways to implement the ideas disclosed within, and said implementations are contemplated by this disclosure.

FIG. 3a illustrates a method for providing an in-flight map display with a majority of processing and image rendering performed on the server. The in-flight map display method of FIG. 3a is driven by the data available on board and has an application on the server 120 that combines all the provided data into a visual map, which is then broadcast to a client, e.g., PED 200. The process starts at step 305 and takes parallel paths to rendering the map. In one path, data is received from the Aircraft Interface Module at step 310, which is then converted into flight specific data at step 320. This converted data is then packaged into a shared data set in step 330. Once packaged, this data is inputted into the server application in step 370.

In the other parallel path, the method requests stored satellite imagery data based on the map being viewed by the user in step 340. This imagery data is stored in a non-graphic format, for example, binary, and may or may not be encrypted and/or compressed. At step 360, the satellite imagery data is rendered into a visual map. A separate text layer may be rendered from information stored on the server 120 (e.g., names of geographical features, airline specific information, menus, etc. . . . ) at step 350. The rendered text map is a separate input to the visual map rendering step 360 and is layered on top of the map. The rendered map with text layer is then sent as an input to the server application at step 370. The server application then combines the flight information with the visual map presentation and sends actual graphic data at step 380 (e.g., full or partial screen jpegs or bitmap frames) to a user interface such as PED 200 or a SDU as described briefly herein and in further detail in U.S. application Ser. No. 13/230,675.

In this embodiment, the client side hardware (e.g., PED 200 or a SDU) is not required to render the maps or perform conversion on flight specific data. Rather all that is required from the client side hardware is to run the flight details application. The flight details application, among other things, displays the graphics data transmitted by the server application on server 120 at step 370. The flight details application also provides user feedback to the interactive map application by presenting menus and accepting user input to facilitate user interaction with the map.

In this embodiment, if each user is allowed to interact differently with the map application, then a extremely large amount of processing power and bandwidth are consumed by the server 120 running the server side application. This type of implementation is preferable for server hardware having such precious power and bandwidth.

FIG. 3b illustrates a method for providing an in-flight map display with a majority of processing and image rendering performed at the client (i.e. PED 200). The in-flight map display method of FIG. 3b is mainly driven by the data available on board and has an application on the server 120 that packages the raw flight specific data and map image data, and then transmits the data to a client, e.g., PED 200, for processing. The process starts at step 305 and takes parallel paths to generate the data package for the client application. In one path, data is received from the Aircraft Interface Module at step 310, which is then converted into flight specific data at step 320. The flight specific data is then inputted into the server application in step 370.

In the other parallel path, the method requests stored satellite imagery data based on the map being viewed by the user in step 340. This imagery data is stored in a non-graphic format, for example, binary, and may or may not be encrypted and/or compressed. The raw stored map imagery data is then sent as an input to the server application step 370. The server application then combines the raw data sets and sends the raw data 380 to a user interface such as PED 200 or a SDU as described briefly herein and in further detail in U.S. application Ser. No. 13/230,675.

In this embodiment, the client side hardware (e.g., PED 200 or a SDU) renders the visual graphics for the maps and perform conversions on flight specific data and/or other calculations using the flight specific data. PED 200 or SDU where available are likewise utilized by the user to present menus and accept user input to facilitate user interaction with the map.

In this embodiment, with each user being allowed to interact differently with the map application, but with the majority of the processing being performed on the user's device (e.g., PED 200) the bandwidth consumed by the server 120 is running the server side application to service all the different clients with different data. With proper compression and communications planning, the bandwidth to implement such a solution can be kept in check thereby allowing the use of a less powerful server than the embodiment described in FIG. 3a.

FIGS. 4 and 5 illustrate two different implementations of the preferred embodiments of FIG. 3.

FIGS. 6A-C illustrate three spatial environments related to the passenger's PED in relationship to the relative location of departure airport, onboard aircraft, and destination airport.

FIG. 4 illustrates a method for providing flight plan and associated details (including a map) to a user on board a flight or associated with a flight, including the ability to interact with the map according to one embodiment of the disclosure. The process starts at step 405, then a determination at step 410 is made as to whether a user is on board the aircraft. If the user is not onboard, the flight details application connects at step 420 to a terrestrial server using, for example local wifi 610 at the departure airport, as shown in FIG. 6A.

It should understood that the network architecture or type and communication media or medium is not limited to wifi. For example, a variety of cellular or data networks may be used, including second-generation wireless telephone technology (2G), 3^{rd} generation of mobile telecommunications technology (3G), fourth generation of mobile phone communications technology (4G), Global System for Mobile Communications (GSM), Enhanced Data rates for Global GSM Evolution (EDGE), 3^{rd} Generation Partnership Project (3GPP), code division multiple access (CDMA), time division multiple access (TDMA), etc. In some embodiments, microwave, satellite, radio and spread-spectrum technology (e.g., 802.11), infrared network, global area network (GAN), wide area network (WAN), internet, and local area network (LAN) may also be used as the network communication methodology and medium. A variety of wired technologies may also be used as the communication medium, including twisted pair wire, coaxial cable, optical fiber, and phone lines, and power lines.

The flight details application downloads from the terrestrial server the flight plan of the user's upcoming flight and other related details at step 425. The download includes data for generating a visual map associated with the flight. At step 430, the user can interact with the map in a plurality of ways as described earlier in this disclosure. For example, the user can view the entire flight plan, fly across the flight plan or any other portion of the map in a simulator type environment, or download tourism features/data regarding different locales, including but not limited to the origination and destination cities. During and/or after each of steps 420, 425, and 430 the method polls the status of the user to determine if the user has boarded the aircraft. If so, the method proceeds to step 440 and connects to the in-flight server. From the in-flight server the process provides the flight details application with a download of flight plans and other related details at step 445. The download includes data for generating a visual map associated with the flight. Once the flight data is downloaded from the onboard server, the user can interact with the map 460 in a plurality of ways, download additional map features 450, and or download/upload flight specific information.

Once the passenger PED is connected to the in-flight server 120, at step 440, (see FIG. 6B) a number of additional features not directly associated with the visual map can be utilized. In one embodiment, utilizing the flight specific data provided to the flight details application, a determination of the landing time and location based on the aircraft position information can generate e-mail, text, or voice mail notifications to entities not on the aircraft (e.g., friends, family, hotel, work, etc. In another embodiment, again utilizing the flight specific data and based on a determination of the aircraft position in relation to connecting flights, the in-flight server 120 can assist passengers in re-booking flights for missed or assumed missed connections. Such re-booking may utilize the specific airline website and/or a customized, dedicated graphical user interface via the flight details application may communicate to the airline's back-end services via an off-aircraft data link (e.g., external entity 140). Alternatively, the flight details application may automatically re-book flights for passengers if connections will be missed. Such automatic action can be implemented through a set of permissions and preferences configured in the PED application by the passenger. The permissions and preferences will act as a rule set to find best options for re-booking utilizing the airline's web interface or proprietary back-end interface and perform actions accordingly.

In another embodiment, the flight details application uses aircraft position information if connected to the in-flight server 120 (such as in FIG. 6B) or GPS data if connected to a terrestrial server (such as in FIG. 6C) to provide the passenger with information regarding destination transit services (e.g., shuttles, taxis, busses, trains, etc.). Based on the aircraft position information and/or GPS information, data is gathered by the in-flight server 120 through the media loader module 150 if pre-loaded onto the aircraft system or through the off-aircraft data link (e.g., external entity 140; or alternatively through a terrestrial server using, for example, local wifi 615 as shown in FIG. 6C to provide the passenger with details regarding their destination.

In a further embodiment, the flight details application can be configured such that maps, direction guides, and/or government/airline procedures for a destination airport are pushed automatically to the passenger while they are connected to the in-flight server 120, in the set-up shown in FIG. 6B. This may occur as soon as the passenger is connected to the in-flight server 120, or it may systematically push this to each of the connected PEDs individually, allowing the system to control bandwidth usage. The destination airport maps and direction guides may be stored “locally” of the aircraft's server(s) 120 or may be provided via the off-aircraft data link connection to a back-end server. The maps and direction guides include (1) terminal maps (e.g., shops, restaurants, restrooms, etc.); (2) duty instructions, if any; (3) immigration instructions, if any; (4) turn-by-turn directions to connecting gate (utilizing a flight itinerary entered into the flight details application by passenger or automatically received from the in-flight server or terrestrial server when the passenger connects to these systems); (5) turn-by-turn directions to baggage claim including indication of baggage carousel obtained from centralized server (utilizing the same flight plan entered by the passenger or received from the in-flight or terrestrial server associate with the passenger's flight details application); and (6) turn-by-turn directions to ground transportation (utilizing the same flight plan entered by the passenger or received from the in-flight or terrestrial server associate with the passenger's flight details application). The automated, pushed terminal maps may also include turn-by-turn directions to navigate through the airport. These directions can be provided to the passenger using audio prompts so that there is not a need to hold or view their PED. The audio prompt can be delivered utilizing voice synthesis and speaker on PED or Bluetooth or wired headphone. The turn-by-turn voice queues are based on GPS and wifi location data available to the flight details application using the local wifi 610/615 of the departure/destination airports, accordingly.

In one embodiment, the flight details application can be configured such that turn-by-turn directions to the passenger's hotel are pushed automatically to the passenger while they are connected to the in-flight server 120 or are available from a terrestrial server at the request of the passenger through the flight details application (utilizing the same flight plan entered by the passenger or received from the in-flight or terrestrial server associate with the passenger's flight details application). The turn-by-turn direction are based on GPS and wifi location data available to the flight details application.

In at least one embodiment, the flight details application can be utilized by persons not onboard or about to board the vessel, to track the status of the flight. In this embodiment, the application would function similarly to that described above, except the data would be different. The actual map data would be transmitted from a terrestrial server, and the flight information would be summary information and would come from a centralized data server and not be real-time like the on-board data.

In another embodiment as illustrated in FIG. 6A, the flight details application may detect when a passenger is at the airport based on their flight plan entered by the passenger or received from the in-flight or terrestrial server associated with the passenger's flight details application and the passenger's GPS location and utilizing the local wifi 610 at the departure airport 600. Once detected, the flight details application may provide a service menu like meal selection, entertainment selection, etc. through a customized, dedicated graphical user interface on the passenger's PED based on data stored on a terrestrial server accessed through local wifi 610. The flight details application may further detect when a passenger is likely to miss their flight based on their flight plan, entered by the passenger or received from the in-flight or terrestrial server associate with the passenger's flight details application, and GPS location, and provide options or initiate actions based on whether the flight details application determines the passenger is going to miss their flight. Options or action that may be provided or undertaken by the flight details application are to rebook flights through automated internet connections to airline website, to otherwise modify travel, to call/email/text/notify co-workers, friends, or family utilizing APIs available on passenger's PED for such standard services.

In another embodiment, the flight details application provides GUI and audible reminders on passenger's PED to pack, leave for the airport, or otherwise prepare for their flight based on travel info flight plan entered by the passenger or received from the in-flight or terrestrial server associate with the passenger's flight details application, GPS location, traffic to airport obtained from available internet sources, etc.

In one embodiment, the flight details application provides marketing and sales messages, incentives and offers for airport vendors or media (movies, games, etc.) to be enjoyed at airport or on aircraft to passenger at airport via a customized, dedicated graphical user interface embodied the flight details application. These features can be locally driven based on the particular signals received from local wifis 610/615 at the departure/destination airports, respectively.

In still another embodiment, the flight details application allows passengers waiting at the airport to preview entertainment options available on their aircraft, set-up or modify playlists, and create profiles of media to watch on the aircraft. This is accomplished through a customized, dedicated graphical user interface embodied in the flight details application, connecting either through an internet connection to a back-end data system. Such functionality can also be localized using wifi in the airport for locally served content, so the passenger does not need to use a cellular data plan.

FIG. 5 illustrates a method of automatic PED prompting, including requesting permission for spoofed GPS data according to one embodiment of the disclosure. The process which starts at step 505 is only an on-board process. Once a PED is detected, a push notification is sent to the device at step 510. The push notification, in addition to preparing a PED for interface with the system disclosed in U.S. application Ser. No. 13/230,675, may request feedback from the user of the PED, at step 520, as to whether they would prefer to use their own third party map application or whether they will be using the customized application designed for optimum interface with the in-flight system. If the PED user answers that they prefer to use a third party map application, the process request permission to “spoof” GPS data to the third party application, at step 540. If it is determined, at step 550, that the PED and the third party application allows spoofing, then spoofed GPS data is provided to the third party application at step 560. If on the other hand it is determined, at step 550, that spoofing is not allowed by the PED or the third party map application, then the process ends, at step 570.

If the PED user prefers the proprietary map program which may be an integral part of the in-flight system or may be a stand alone product running on the aircraft's server 120, the process provides the Aircraft Interface Info, at step 530, and the interactive map application utilizes this information to provide the user with an interactive visual map environment. As either the third party application or the proprietary application are running on a user controlled PED, the user has control over the continuation of the program and can end either process, at step 570, as would be understood by a person of ordinary skill in the art. For example, requesting the PED enter a home screen by indication of a user input.

Additional embodiments of the disclosure include identify groups of people traveling together and enable immediate, seamless onboard messaging between them (including email, txt, pictures, chat, video, & audio) using either the flight details application or other 3rd party applications. This is accomplished by having the passenger configure the group traveling together in their contact list prior to the flight. The application on the passenger's PED will communicate to a web-based back end server to determine the flight configuration of all members of the group. Once on the aircraft, connection to our servers will provide positive identification of seat location for every member of the group (communicated to the PED from the server), and APIs available on the passenger's PED will allow the application to liaise between the flight details application and third-party applications to enable direct communication between members of the group)

Another embodiment of the disclosure provides a mechanism for “pilot tweets” where the pilot, co-pilot, or other crew member sends tweets or other short messages to passengers' devices informing them of interesting or relevant data. These tweets or short messages will be delivered from the crew member via a PED or FAP or other portable electronic device into the on-board system of servers. The messages will then be propagated to all attached clients, whether they are using the flight details application, or optionally an available third-party app, and will display the messages.

What is claimed is:

1. A method for providing a different interactive map to each of a plurality of passengers on an aircraft, comprising
receiving and converting flight specific data from an aircraft interface module;
retrieving map imagery data stored on a media server located on the aircraft;
first rendering a graphical representation of the retrieved map imagery data;
second rendering a text layer to be overlaid on the graphical representation of the retrieved map imagery data from the media server;
packaging the flight specific data, the graphical representation of the retrieved map imagery data, and the text layer with a server based application; and
transmitting the package data to a client based application for display.

2. The method of claim 1, further comprising:
receiving a request from the client based application for different imagery and text data; and
repeating the retrieving, first and second rendering, packing, and transmitting steps based on received request from the client based application.

3. The method of claim 2, further comprising:
compressing the package data prior to the transmitting step.

4. The method of claim 3, further comprising:
discarding one or more earlier received requests which have not yet been rendered when a new request is received from the same client based application, thereby rendering the requests in a last in, first out (“LIFO”) order.

5. The method of claim 4, wherein the client application has no map imagery data.

6. The method of claim 5, wherein the package data is configured to permit no rendering to be done by the client application during display.

7. The method of claim 6, further comprising:
sending a map of a destination airport to the client based application on a passenger PED, the map including a terminal map and restaurants.

8. The method of claim 7, further comprising:
sending an assigned baggage claim number at the destination airport for the aircraft and associated flight to the client based application.

9. The method of claim 8, further comprising:
sending government customs procedures at the destination airport to the client based application.

10. A method comprising:
requesting flight specific data and map imagery using a client based application running on a personal electronic device (“PED”);
receiving a raw data stream from a server application running on a media server comprising:
converted flight specific data, and
stored map imagery data;
rendering the map imagery data per instructions of the client based application; and
displaying the rendered map imagery data and a text layer on the PED.

11. The method of claim 10, further comprising:
receiving at least one polling request on the PED as to whether the passenger has boarded an aircraft;
connecting to an in-flight server of the aircraft upon receipt of the polling request via the PED; and
downloading data for generating a visual map associated with the aircraft on the PED.

12. The method of claim 11, further comprising:
continuously receiving flight specific data on the PED while on board the aircraft, the flight specific data including aircraft position and expected landing time.

13. A method comprising:
detecting a position of an aircraft based on data from a aircraft interface module;
calculating an expected arrival time of the aircraft at a destination airport based on the aircraft position;
determining whether the aircraft is ahead or behind schedule based on the expected arrival time;
retrieving a flight itinerary for a passenger personal electronic device (“PED”) including a scheduled connecting flight at the destination airport;
providing an earlier connecting flight to the passenger PED for booking if the aircraft is ahead of schedule; and
providing a later connecting flight to the passenger PED for booking if the aircraft is behind schedule.

14. The method of claim 13, further comprising:
automatically re-booking the later connecting flight when the scheduled connecting flight has already departed the destination airport.

15. The method of claim 14, further comprising:
checking a set of permissions and preferences on the passenger PED prior to re-booking to determine whether automatic re-booking is enabled.

16. The method of claim 15, wherein the preferences specify a minimum layover time between the expected arrival time and departure time of an alternative connecting flight.

17. The method of claim 16, wherein the preferences specify alternative airports to reach as a final destination.

18. The method of claim 17, wherein the detected position is based on aircraft position information from an in-flight server.

19. The method of claim 17, wherein the detected position is based on a global positioning system (“GPS”).

20. The method of claim 17, wherein the detected position is based on wifi location data.
